(19) United States
(12) Patent Application Publication
(10) Pub. No.: US 2010/0245085 A1
(43) Pub. Date: Sep. 30, 2010

(54) INFORMATION PROCESSING APPARATUS AND INFORMATION PROCESSING METHOD

(75) Inventors: Hiroki Mochizuki, Shizuoka (JP); Yoshihiko Ikeda, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/712,436

(22) Filed: Feb. 25, 2010

(30) Foreign Application Priority Data
Mar. 27, 2009 (JP) 2009-079919

(51) Int. Cl. G08B 21/00

(52) U.S. Cl. 340/540

(57) ABSTRACT

An information processing apparatus includes: a shelf-label control unit connected to plural shelf label terminals, which are arranged in predetermined positions in a store, and configured to transmit instruction information for instructing predetermined operation to each of the shelf label terminals; an information collecting unit connected to the plural sensor terminals, which are arranged in the predetermined positions in the store, and configured to collect environment information around the arrangement positions acquired by the sensor terminals; and a collection control unit configured to cause the information collecting unit to start the collection of the environment information with response information from the shelf label terminals, which responds to an instruction signal transmitted from the shelf-label control unit, as a trigger.

### CROSS-REFERENCE TO RELATED APPLICATION

This application claims the benefit of priority from Japanese Patent Application No. 2009-079919 filed on Mar. 27, 2009, the entire content of which is incorporated, herein by reference.

### TECHNICAL FIELD

The present invention relates to an information processing apparatus and an information processing method for controlling the operation of a shelf label terminal arranged in a store.

### BACKGROUND

Conventionally, for example, in a selling floor of a store, a system called an electronic shelf label system is introduced in order to present customers with commodity prices and the like. In such an electronic shelf label system, shelf label terminals (electronic price tab display terminals) set in the selling floor communicate with a control apparatus by radio communication, whereby contents of display on the shelf label terminals can be updated by the control apparatus. For example, Japanese Patent No. 3560988 discloses the basic configuration of a system and a control method for displaying price information on plural shelf label terminals set in commodity shelves and the like in a store.

Since a situation in the store changes at any time, it is necessary to perform management corresponding to the change. In this case, it is possible to improve convenience of the management by grasping the situation change in the store using a so-called sensor network system configured to collect information from various sensors. However, since the sensor network system is a system independent from the electronic shelf label system, the sensor network system needs to be separately installed and cost increases. Therefore, there is a demand for a technique that makes it possible to easily realize both the electronic shelf label system and the sensor network system. The shelf label terminals disclosed in Japanese Patent No. 3560988 can provide customers and store clerks with necessary information. However, since the sensor network system is not taken into account, the problem cannot be solved.

### SUMMARY

According to an aspect of the present invention, there is provided an information processing apparatus including:

a shelf-label control unit connected to plural shelf label terminals, which are arranged in predetermined positions in a store, and configured to transmit instruction information for instructing predetermined operation to each of the shelf label terminals;

an information collecting unit connected to the plural sensor terminals, which are arranged in the predetermined positions in the store, and configured to collect environment information around the arrangement positions acquired by each of the sensor terminals; and

a collection control unit configured to cause the information collecting unit to start the collection of the environment information with response information from the shelf label terminals, which responds to an instruction signal transmitted from the shelf-label control unit, as a trigger.

According to another aspect of the present invention, there is provided an information processing method including:

a shelf-label control unit transmitting instruction information for instructing predetermined operation to each of plural shelf label terminals arranged in predetermined positions in a store;

an information collecting unit collecting, from the plural sensor terminals arranged in the predetermined positions in the store, environment information around the arrangement positions acquired by each of the sensor terminals; and

a collection control unit causing the information collecting unit to start the collection of the environment information with response information from the shelf label terminals, which responds to an instruction signal transmitted from the self-label control unit, as a trigger.

### DESCRIPTION OF THE DRAWINGS

FIG. 1 is a schematic diagram of an example of a store information system;

FIG. 2 is a diagram of a commodity information record of a commodity master DB;

FIG. 3 is a diagram of a shelf label management record of an ESL server;

FIG. 4 is a front view of a shelf label terminal shown in FIG. 1;

FIG. 5 is a diagram of the configuration of a main part of the shelf label terminal shown in FIG. 1;

FIG. 6 is a diagram of the configuration of a main part of a sensor terminal shown in FIG. 1;

FIG. 7 is a module diagram of a personal computer;

FIG. 8 is a module diagram of a radio communication apparatus;

FIG. 9 is a ladder chart for explaining the operation of the store information system;

FIG. 10 is a schematic diagram of a basic frame configuration used in communication between a repeater and the terminals (the shelf label terminal and the sensor terminal);

FIG. 11 is a flowchart for explaining an operation example of the store information system in which an acceleration sensor is used as the sensor terminal;

FIG. 12 is a flowchart for explaining an operation example of the store information system in which a radio wave sensor is used as the sensor terminal;

FIG. 13 is a flowchart for explaining an operation example of the store information system in which a temperature sensor is used as the sensor terminal; and

FIG. 14 is a flowchart for explaining an operation example of the store information system in which an infrared sensor is used as the sensor terminal.

### DETAILED DESCRIPTION

An information processing apparatus and an information processing method according to an embodiment of the present invention are explained in detail below with reference to the accompanying drawings.

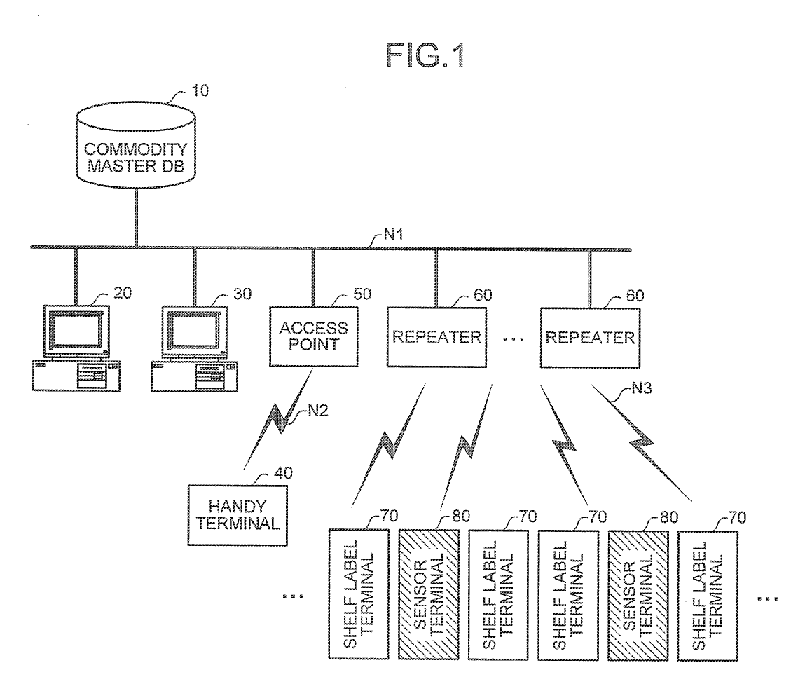

FIG. 1 is a schematic diagram of the overall configuration of a store information system according to an embodiment of the present invention. As shown in the figure, the store information system includes a commodity master DB (database) 10, a POS (Point Of Sales) server 20, an ESL (Electronic Shelf Label) server 30, a handy terminal 40, an access point 50, repeaters 60, shelf label terminals 70, and sensor terminals 80.

The commodity master DB 10, the POS server 20, the ESL server 30, the access point 50, and the repeaters 60 are connected via a wired network N1. The access point 50 and the handy terminal 40 are connected via a wireless network N2. The repeaters 60 and the terminals (the shelf label terminals 70 and the sensor terminals 80) are connected via a wireless network N3.

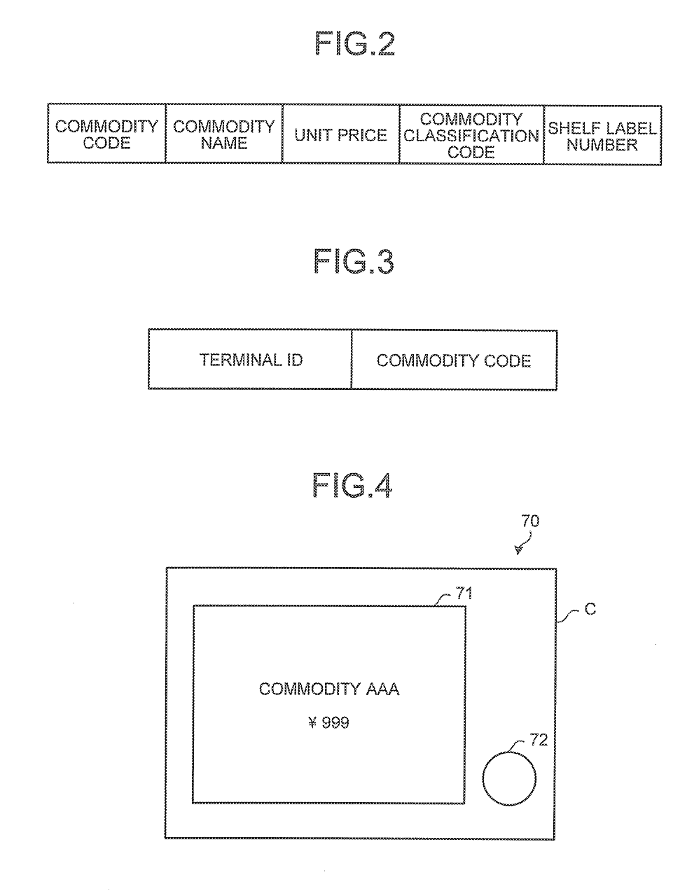

The commodity master DB 10 is a database apparatus configured to store and manage information concerning names and prices of commodities sold by a store. Specifically, as shown in FIG. 2, the commodity master DB 10 has stored therein a commodity information record including data items such as a commodity code, a commodity name, a unit price, a commodity classification code, and a shelf label number. The commodity code is a peculiar code set in advance for each of commodities in order to identify various commodity items sold in the store. The commodity name, the unit price, the commodity classification code, and the shelf label number are information concerning the commodities specified by the commodity code of the same record.

The POS server 20 is a computer functioning as a core of a POS system and is connected to a not-shown POS terminal via a communication line. The POS terminal is a terminal configured to register sales data of commodities purchased by a customer and settles payment for the commodities according to various payment methods such as cash, a credit card, a prepaid card, electronic money, and a debit card. When the POS server 20 receives an instruction for display rewriting or the like for a specific shelf label terminal 70 from an operator of the POS server 20, the POS terminal, or the like, the POS server 20 transmits instruction data indicating content of the instruction to the ESL server 30.

The ESL server 30 is a server configured to realize functions of a shelf-label control unit, an information collecting unit, and a collection control unit in conjunction with the repeaters 60 and manage an ESL system and a sensor network system explained later.

Specifically, when the ESL server 30 receives the instruction data from the POS server 20, the ESL server 30 generates a command and data (the command and the data are hereinafter simply referred to as command data) for causing the shelf label terminal 70 designated by the instruction data to execute operation instructed by the instruction data and transmits the command data to the shelf label terminal 70 via the repeaters 60. When the ESL server 30 receives environment information as a detection result in the sensor terminals 80 via the repeaters 60, the ESL server 30 performs alert of a warning message or the like according to a measurement value of a predetermined event included in the environment information.

The ESL server 30 includes a not-shown storage device such as an HDD and stores therein a shelf label management record in which terminal IDs for identifying the respective shelf label terminals 70 and commodity codes for identifying commodities displayed on the shelf label terminals 70 are associated (see FIG. 3). FIG. 3 is a block diagram of the shelf label management record of the ESL server 30. Information stored in the storage device is not limited to the above. For example, the storage device may store terminal IDs (e.g., IP addresses) of the sensor terminals 80 and position information indicating setting positions of the sensor terminals 80 in association with each other.

The handy terminal 40 is a portable data collecting apparatus that has functions of a code reader for reading a barcode and a two-dimensional code, an OCR (Optical Character Reader), a tag reader for reading an RFID tag, and the like and is operated by store clerks and the like in the store. The handy terminal 40 reads the terminal ID of the shelf label terminal 70 and a commodity code of a commodity displayed on the shelf label terminal 70 and transmits the terminal ID and the commodity code to the ESL server 30 via the access point 50 to thereby resister both the data in association with the shelf label management record.

The access point 50 is a wireless network apparatus for connecting the apparatus (the ESL server 30) connected to the wired network N1 and the handy terminal 40 and performs protocol conversion between a wireless LAN and a wired LAN. The repeater 60 is a wireless network apparatus for connecting the apparatus (the ESL server 30) connected to the wired network N1 and the shelf label terminals 70 and the sensor terminals 80 and performs protocol conversion between the wireless LAN and the wired LAN.

The shelf label terminal 70 is provided on a commodity display shelf in the store to correspond to each of displayed various commodities and displays (presents) information concerning the commodity corresponding to the shelf label terminal 70. A front view of the shelf label terminal 70 is shown in FIG. 4. The configuration of a main part of the shelf label terminal 70 is shown in FIG. 5.

As shown in FIG. 4, the shelf label terminal 70 has, on a front side of a housing C formed in a label shape, a display unit 71 for displaying a commodity name, a price, and the like and a terminal-ID presenting unit 72 functioning as an interface unit for interfacing with the handy terminal 40. As shown in FIG. 5, the shelf label terminal 70 is mounted with, in the housing C, a battery 73 as a driving source, a communication unit 74 configured to perform data communication with the ESL server 30 via the repeater 60, a nonvolatile storing unit 75, a timer unit 76 used for synchronization and time measurement during communication control, and a control unit 77 configured to control these units.

The storing unit 75 has stored therein a terminal ID allocated and set for each of the shelf label terminals 70 in order to identify the shelf label terminal 70. The storing unit 75 stores data such as a commodity name and a price related to display on the display unit 71 transmitted from the ESL server 30.

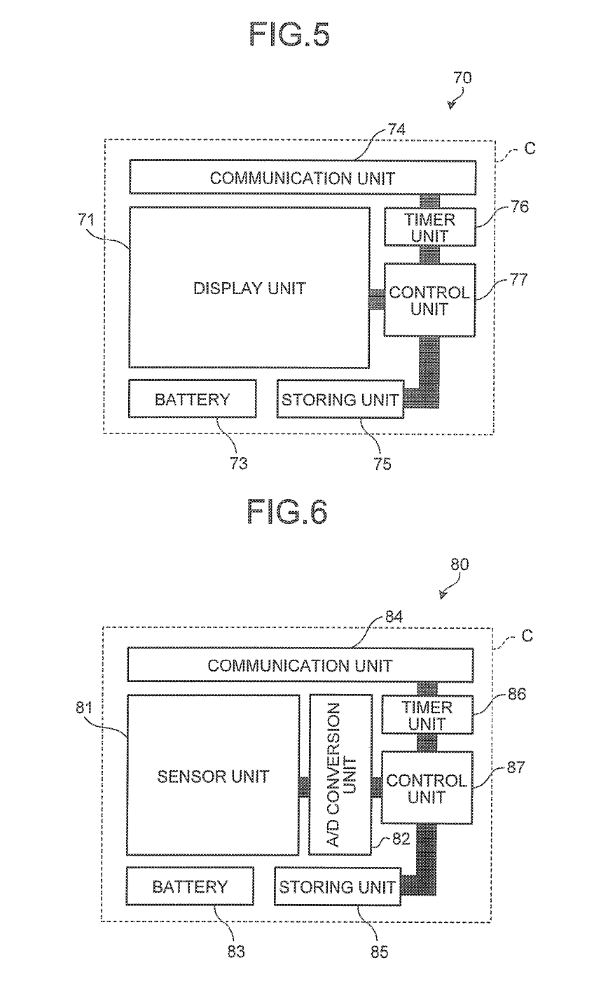

Like the shelf label terminal 70, the sensor terminal 80 is provided on a commodity display shelf in the store or a position corresponding to an event to be detected. The configuration of a main part of the sensor terminal 80 is shown in FIG. 6.

The sensor terminal 80 is mounted with, in the housing C same as that of the shelf label terminal 70, a sensor unit 81 configured to acquire environment information, an A/D conversion unit 82 configured to convert an analog output as a detection result of the sensor unit 81 into digital data; a battery 83 as a driving source, a communication unit 84 configured to perform data communication with the ESL server 30 via the repeater 60, a nonvolatile storing unit 85, a timer unit 86 used for synchronization and time measurement during communication control, and a control unit 87 configured to control these units.

Various forms of the sensor unit 81 are conceivable. However, in this embodiment, an acceleration sensor, a temperature sensor, a radio wave sensor, and an infrared sensor are used.

The storing unit 85 has stored therein a terminal ID allocated and set for each of the sensor terminals 80 in order to identify the sensor terminal 80. The storing unit 85 stores, under the control by the control unit 87, as a change detection history, a detection result of the sensor unit 81 converted into digital data by the A/D conversion unit 82.

As explained above, in this embodiment, a housing same as that of the shelf label terminal 70 is adopted as the housing of the sensor terminal 80. Specifically, to realize the sensor terminal 80, if only the sensor unit 81 including the A/D conversion unit 82 is connected instead of the display unit 71 of the shelf label terminal 70, the other components may be the same as those of the shelf label terminal 70. With such a configuration, it is possible to inexpensively manufacture the sensor terminal 80. Further, since the sensor terminal 80 can be set in a position where the shelf label terminal 70 can be set, it is possible to improve convenience related to a setting position.

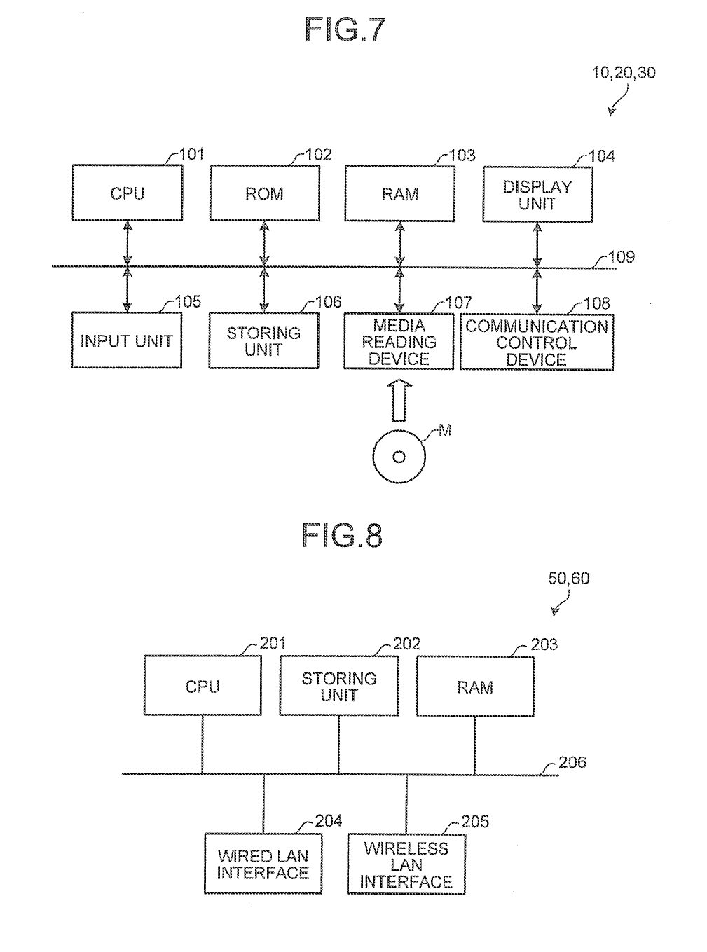

The commodity master DB 10, the POS server 20, and the ESL server 30 are general computers. FIG. 7 is a diagram of the module configuration of each of the computers. Each of the computers as the commodity master DB 10, the POS server 20, and the ESL server 30 includes a CPU (Central Processing Unit) 101 configured to process information, a ROM (Read Only Memory) 102 having stored therein a BIOS and the like, a RAM (Random Access Memory) 103 configured to rewritably store various data, a display unit 104 such as a CRT (Cathode Ray Tube) or an LCD (Liquid Crystal Display) configured to display processing progress, a processing result, and the like, an input unit 105 as a pointing device such as a keyboard or a mouse used by an operator to input a command, information, and the like to the CPU 101, a storing unit 106 such as an HDD (Hard Disk Drive) configured to function as various databases and store various computer programs, a media reading device 107 such as a CD-ROM drive for storing information using a storage medium M, distributing information to the outside, and acquiring information from the outside, and a communication control device 108 for transmitting information through communication with other apparatuses on the outside via various communication lines. These units are connected by a bus 109.

In such a computer, when an operator turns on a power supply, the CPU 101 starts a computer program called loader in the ROM 102, reads a computer program called OS (Operating System) for managing hardware and software of the computer from the storing unit 106 into the RAM 103, and starts the OS. Such an OS starts a computer program, reads information, and stores the information according to the operation by the operator. As representative OSs, Windows (registered trademark) and the like are known. An operation program running on these OSs is called application program. The application program is not limited to an application program running on a predetermined OS and may be an application program that causes an OS to take over execution of a part of various kinds of processing explained later or may be an application program included as a part of a group of program files forming predetermined application software, OS, or the like.

In other words, according to a difference of an application program stored in the storing unit 106, the computer functions as each of the commodity master DB 10, the POS server 20, and the ESL server 30.

In general, an application program installed in the storing unit 106 of a personal computer is recorded in the storage medium M such as media of various system including various optical disks such as a CD-ROM and a DVD, various magneto-optical disks, various magnetic disks such as a flexible disk, and a semiconductor memory. An operation program recorded in the storage medium M is installed in the storing unit 106. Therefore, the storage medium M having portability including an optical information recording medium such as a CD-ROM and a magnetic medium such as an FD could be a storage medium for storing the application program. The application program may be, for example, captured from the outside via the communication control device 108 and installed in the storing unit 106.

In the personal computer, when the application program running on the OS is started, the CPU 101 executes various kinds of arithmetic processing and collectively controls the units according to the application program.

The access point 50 and the repeaters 60 are general radio communication apparatuses. FIG. 8 is a module diagram of each of the radio communication apparatuses. Each of the radio communication apparatuses as the access point 50 and the repeaters 60 includes a CPU 201 configured to process information concerning protocol conversion and the like, a storing unit 202 such as an EEPROM having stored therein a BIOS, various computer programs, setting information, and the like, a RAM 203 configured to rewritably store various data, a wired LAN interface 204 for transmitting information through communication with other apparatuses on the wired LAN, and a wireless LAN interface 205 for transmitting information through communication with other apparatuses on the wireless LAN. These units are connected to a bus 206.

In such a radio communication apparatus, when the operator turns on a power supply, the CPU 201 executes a computer program in the storing unit 202 and performs operation corresponding to setting information to thereby realize a function of the radio communication apparatus. In other words, according to a difference of a computer program and setting information stored in the storing unit 202, the radio communication apparatus functions as each of the access point 50 and the repeaters 60.

As shown in FIG. 1, the shelf label terminals 70 and the sensor terminals 80 are connected to the ESL server 30 via the repeaters 60. The ESL server 30 and the shelf label terminals 70 configure an electronic shelf label system (hereinafter referred to as ESL system). The ESL server 30 and the sensor terminals 80 configure a sensor network system. In other words, the store information system realizes both the ESL system and the sensor network system.

The operation of the store information system as the ESL system is explained below. The ESL server 30 receives an instruction from the POS server 20. When the instruction is, for example, an instruction for instructing rewriting of a specific shelf label terminal 70, the ESL server 30 reads out commodity information and price information related to the instruction from the commodity master DB 10 and generates image data for display (hereinafter referred to as display image). The ESL server 30 applies processing such as data packetization for dividing the display image to the display image in order to transmit the display image to the shelf label terminal 70 using a predetermined protocol and transmits a packet to the designated shelf label terminal 70 via the repeater 60.

When the repeater 60 receives the packet from the ESL server 30, the repeater 60 transfers the packet to the designated shelf label terminal 70 after converting the protocol into a predetermined wireless protocol. When the shelf label terminal 70 receives the packet from the repeater 60, the shelf label terminal 70 composes the display image from the packet and displays the display image on the display unit 71. Functions that can be instructed to the shelf label terminal 70 from the POS server 20 and the ESL server 30 are not limited to the display rewriting function explained above. Various settings are defined such that various functions such as survival check for the shelf label terminal 70, check of battery power, and refresh of display can be realized. Communication for data exchange between the repeater 60 and the shelf label terminal 70 is performed in a period of a time slot specified by a basic frame explained later.

The operation of the store information system as the sensor network system is explained below. One or plural sensor terminals 80 are arranged in a predetermined position(s) in a space in the store corresponding to an event to be detected. The ESL server 30 receives environment information transmitted from the sensor terminals 80 at predetermined timing via the repeaters 60 and executes predetermined processing such as emission of a warning according to the environment information. Communication for data exchange between the repeaters 60 and the sensor terminals 80 is performed in a predetermined period secured at a post-stage of a period (a time line) for performing communication between the repeaters 60 and the shelf label terminals 70 as explained later.

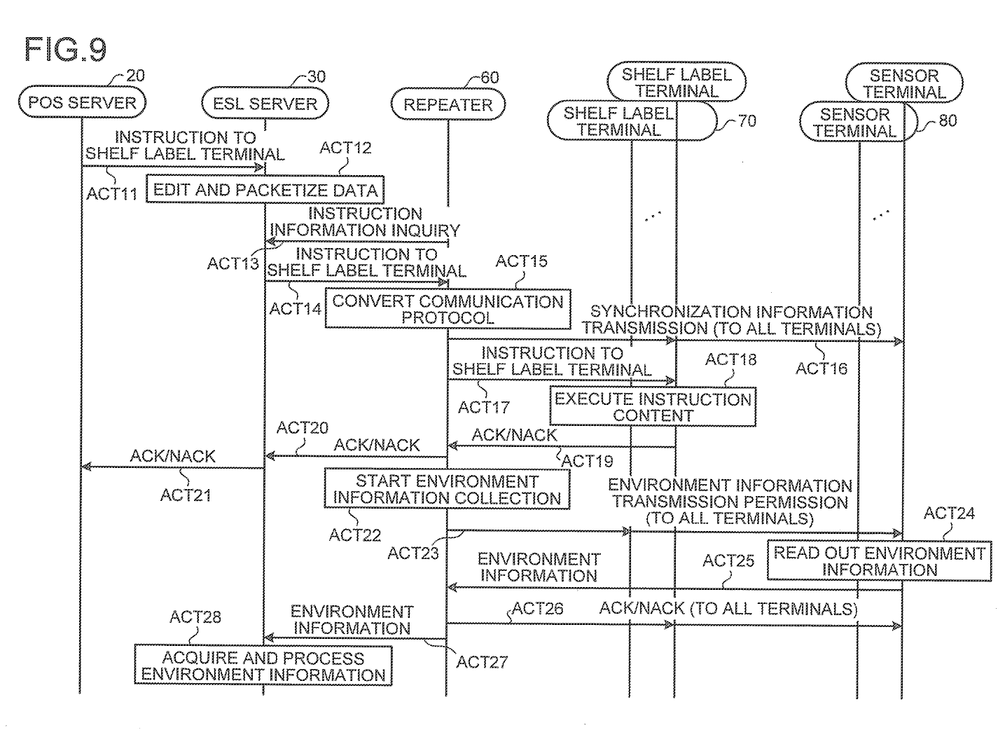

The overall operation of the store information system is explained below with reference to FIG. 9. FIG. 9 is a ladder chart for explaining the overall operation of the store information system.

As explained above, the store information system includes the POS server 20, the ESL server 30, the repeaters 60, the shelf label terminals 70, and the sensor terminals 80. In a form shown in FIG. 9, an instruction issued from the POS server 20 to a specific shelf label terminal 70 is sequentially transferred to the apparatuses and reaches the shelf label terminal 70 and, after acknowledgement by the shelf label terminal 70 is obtained, communication with the sensor terminal 80 is started. Processing executed in the apparatuses is realized by cooperation of CPUs and predetermined computer programs of the apparatuses. However, in the following explanation, for convenience of the explanation, execution entities of the processing are described as the names of the apparatuses.

First, the POS server 20 transmits instruction information for the specific shelf label terminal 70 to the ESL server 30 (Act 11). The ESL server 30 receives the instruction information from the POS server 20 and generates command data according to content instructed by the instruction information. The ESL server 30 applies encryption or the like for division, editing, or information confidentiality to the generated command data in order to packetize the command data in a data structure conforming to protocols used by the repeater 60 and the shelf label terminal 70 (Act 12).

In the example of this processing, the following communication between the ESL server 30 and the repeater 60 is started by a kick from the repeater 60. When the repeater 60 inquires of the ESL server 30 about provision of a terminal ID and a transfer instruction (Act 13), the ESL server 30 transmits the packetized command data to the repeater 60 as a response to the inquiry (Act 14).

Each of the repeaters 60 sends an inquiry to the ESL server 30 using a carrier sense of a CSMA (Carrier Sense Multiple Access) system or the like such that collision of communication does not occur between the repeater 60 and the other repeaters 60. Packets (the command data) transmitted in Act 14 include a terminal ID of the shelf label terminal 70 that is a target of an instruction.

The repeater 60 converts the command data (the packets and the protocol) transmitted from the ESL server 30 into a predetermined data format in order to communicate with the shelf label terminal 70 and the sensor terminal 80 using a predetermined wireless protocol explained later (Act 15). Subsequently, the repeater 60 broadcasts a synchronization signal for synchronizing with the shelf label terminals 70 and the sensor terminals 80 to the terminals (the shelf label terminals 70 and the sensor terminals 80) (Act 16) and then transmits the command data generated in Act 15 thereto (Act 17).

The synchronization signal is used by the terminals (the shelf label terminals 70 and the sensor terminals 80) to participate in the store information system in synchronization with the repeaters 60 and maintain the participation. In this processing, a terminal ID of a specific terminal (shelf label terminal 70) is described in the synchronization signal.

The shelf label terminal 70 as the instruction target that receives the command data from the repeater 60 in this way executes processing corresponding to instruction content (e.g., display rewriting) according to the command data (Act 18). The shelf label terminal 70 transmits ACK or NACK corresponding to an execution result to the repeater 60 (Act 19). The ACK or NACK is sequentially transferred while being subjected to predetermined protocol conversion and transmitted to the POS server 20, which issues the first instruction, as a confirmation signal (Act 20 and Act 21).

The repeater 60 that receives the ACK or NACK from the shelf label terminal 70 starts collection of environment information from the sensor terminals 80 (Act 22). Specifically, the repeater 60 broadcasts a signal for instructing permission of environment information transmission as a new synchronization signal to all the terminals (the shelf label terminals 70 and the sensor terminals 80) (Act 23). In this processing, the permission of the environment information transmission is instructed with reception of the ACK or NACK as a trigger. However, the permission of the environment information transmission may be instructed only when ACK is received.

When each of the sensor terminals 80 receives the permission of the environment information transmission, the sensor terminal 80 reads out a change detection history stored in the storing unit 85 (Act 24) and transmits the change detection history to the repeater 60 as environment information together with a terminal ID of the sensor terminal 80 (Act 25). Each of the sensor terminals 80 transmits the environment information to the repeater 60 using the carrier sense of the CSMA system or the like such that collision does not occur between the sensor terminal 80 and the other sensor terminal 80.

On the other hand, the repeater 60 receives the environment information from the sensor terminals 80 and transmits ACK or NACK corresponding to a result of the reception to the sensor terminals 80 (Act 26). If the repeater 60 determines that the environment information is normally received, the repeater 60 transmits ACK to the sensor terminals 80 and shifts to Act 27. If the repeater 60 determines that the environment information is not normally received, the repeater 60 transmits MACK including a terminal ID of a terminal (the sensor terminal 80) in which a reception error occurred to the sensor terminals 80. When NACK is transmitted from the repeater 60, the sensor terminal 80 corresponding to the terminal ID included in the NACK attempts retransmission of the environment information.

The environment information transmitted from the sensor terminal 80 is converted by the repeater 60 into a protocol used in communication with the ESL server 30 and then transmitted to the ESL server 30 (Act 27). When the ESL server 30 receives the environment information from the repeater 60, the ESL server 30 executes predetermined processing such as presentation of a warning message according to a measurement value included in the environment information (Act 28).

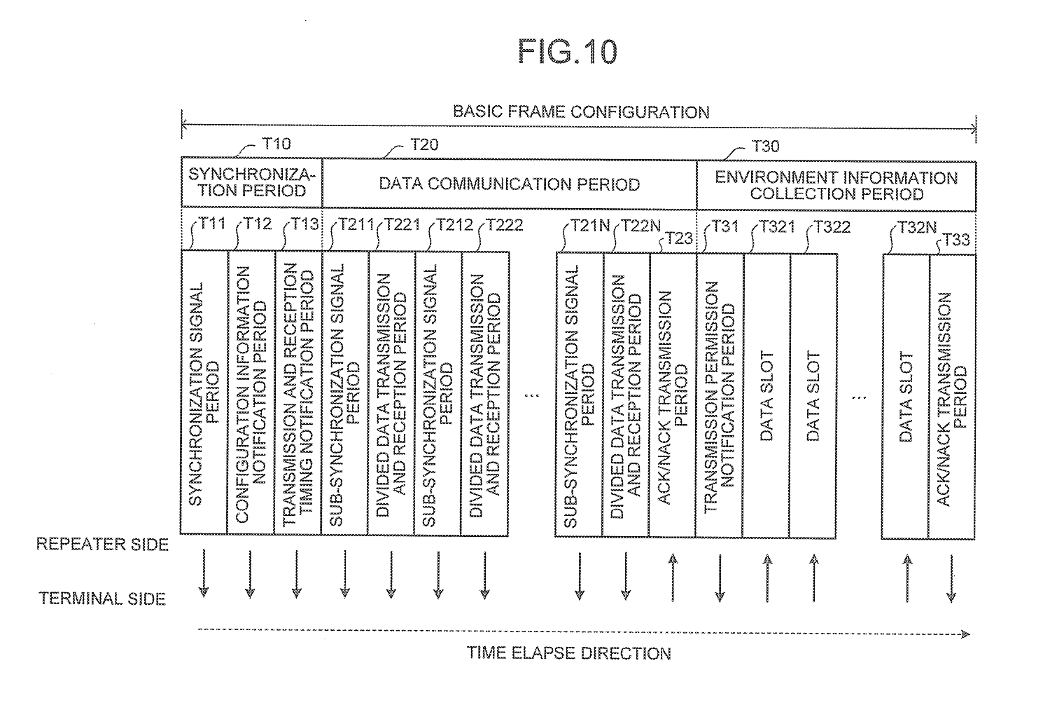

The configuration of a basic frame used in the wireless protocol between the repeaters 60 and the shelf label terminals 70 and sensor terminals 80 is explained with reference to FIG. 10. FIG. 10 is a schematic diagram of a basic frame configuration used in communication between the repeaters 60 and the terminals (the shelf label terminals 70 and the sensor terminals 80). A group of arrows in the up to down direction shown in a lower part of the figure represents in which direction communication in slots is mainly directed (from the repeaters 60 to the terminals (the shelf label terminals 70 and the sensor terminals 80) or from the terminals (the shelf label terminals 70 and the sensor terminals 80) to the repeaters 60). An arrow indicated by a broken line at the bottom of the figure represents a direction in which time elapses when the basic frame is used.

As shown in FIG. 10, the basic frame roughly includes three portions. Specifically, the basic frame includes a synchronization period T10 for synchronizing the repeater 60 and the shelf label terminal 70, a data communication period T20 for exchanging data between the repeater 60 and the shelf label terminal 70, and an environment information collection period T30 for exchanging data between the repeater 60 and the sensor terminal 80.

The synchronization period T10 includes a synchronization signal period T11 necessary for the repeater 60 and the shelf label terminal 70 to physically perform synchronization of clocks, a configuration information notification period T12 for notifying the shelf label terminal 70 of the configuration of the basic frame and exchanging basic frame configuration information in which information concerning, for example, how long time ahead of the synchronization signal a time slot having what kind of time width is present is described, and a transmission and reception timing notification period T13 for exchanging of transmission and reception timing information in which a communication target terminal address indicating an address of a communication terminal and timing for transmission and reception are described.

In the data communication period T20, plural sub-synchronization signal periods (T211, T212, . . . , and T21N) and divided data transmission and reception periods (T221, T222, . . . , and T22N) in which command data is transmitted are alternately provided (N is a natural number equal to or larger than 3). Further, in the data communication period T20, an ACK or NACK transmission period T23 for a response (ACK or NACK) of the shelf label terminal 70 to the command data transmitted from the repeater 60 during the divided data transmission and reception periods is provided.

Periods including the sub-synchronization signal periods, the divided data transmission and reception periods, and the ACK or NACK transmission period are equivalent to time slots in this basic frame. The time slots are used for transmission of the command data to the shelf label terminal 70. When all the data cannot be transmitted in one time slot, the repeater 60 divides the data and transmits the data over plural time slots. When plural shelf label terminals 70 as transmission targets are present, the repeater 60 sequentially allocates the time slots to the shelf label terminals 70 and performs transmission and reception in order to prevent collision of communication among the shelf label terminals 70.

The environment information collection period T30 includes a transmission permission notification period T31 for exchange of environment information transmission permission from the repeater 60, plural data slots (T321, T322, . . . , and T32N: N is a natural number equal to or larger than 3) for environment information transmission, and an ACK or NACK transmission period T33 for transmitting, from the repeater 60, ACK or NACK representing whether the environment information is normally received.

The sensor terminal 80 transmits the environment information to the repeater 60 using the data slots T321, T322, . . . , and T32N. However, the sensor terminal 80 uses a free data slot in order to prevent collision with the other sensor terminals 80. Specifically, first, the sensor terminal 80 performs carrier sense and, after confirming that the other sense terminals 60 are not performing communication, transmits the environment information. When the other sensor terminals 80 are using all the data slots, the sensor terminal 80 stays on standby until any one of the data slots becomes free. Each of the sensor terminals 80 determines success or failure of the environment information transmission on the basis of the ACK or NACK transmitted from the repeater 60. When the sensor terminal 80 receives NACK and determines that the environment information transmission fails, the sensor terminal 80 keeps the environment information until the next opportunity and performs retransmission of the environment information at predetermined timing.

It is possible to realize both the communication with the shelf label terminal 70 and the communication with the sensor terminal 80 using the basic frame explained above. In an example shown in FIG. 10, the command data is transmitted from the ESL server 30 to the repeater 60 with the inquiry from the repeater 60 as a trigger. However, the present invention is not limited to this. The command data may be transmitted from the ESL server 30 to the repeater 60 every time without sending an inquiry to the repeater 60. In this embodiment, the ESL server 30 and the repeater 60 are separate. However, the present invention is not limited to this. The ESL server 30 and the repeater 60 may be integrally configured.

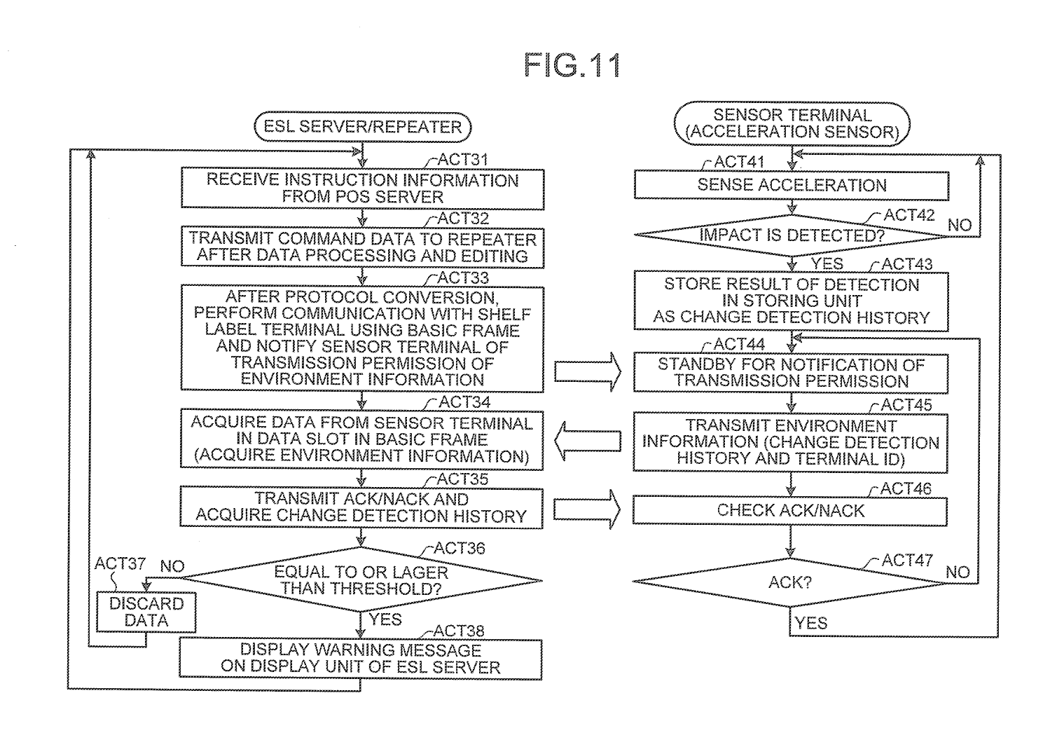

A specific operation example of the store information system is explained with reference to FIGS. 11 to 14. In each of FIGS. 11 to 14, processing executed in each of the ESL server 30 and the repeater 60 corresponding to the information processing apparatus is shown in one flowchart.

FIG. 11 is a flowchart for explaining an operation example of the store information system in which an acceleration sensor is used as the sensor unit 81 of the sensor terminal 80. Commodities are displayed on commodity shelves and flat tables in the store. Electronic price tags such as ESLs, POPs, and the like are attached to the commodities. When a customer or a cart bumps into a shelf or shelf labels, it is likely that the commodity display collapses or the shelf labels fall. In this operation example, it is assumed that the impact on the shelf or the shelf labels is detected by the acceleration sensor of the sensor terminal 80.

First, the ESL server 30 receives instruction information (display rewriting, survival check, etc.) for a specific shelf label terminal 70 from the POS server 20 (Act 31). The ESL server 30 generates command data for realizing content of the instruction and, after processing and editing the command data, transmits the command data to the repeater 60 (Act 32).

The repeater 60 converts a protocol of the data received from the ESL server 30, performs communication with the shelf label terminal 70 using the basic frame, and notifies the sensor terminal 80 of transmission permission for environment information (Act 33). Although no shown in the figure, since the command data is transmitted to the shelf label terminal 70 by using the basic frame, operation corresponding to the instruction content is executed by the designated shelf label terminal 70.

On the other hand, the sensor terminal 80 senses acceleration always or at every predetermined time (Act 41) and repeats processing in Act 41 until acceleration (impact) is detected (No in Act 42). If impact is detected (Yes in Act 42), the sensor terminal 80 stores a result of the detection in the storing unit 85 as a change detection history (Act 43), and stays on standby until transmission permission is transmitted from the repeater 60 (Act 44). When the sensor terminal 80 receives the transmission permission transmitted from the repeater 60 in Act 33, the sensor terminal 80 reads out the change detection history stored in the storing unit 85 and transmits environment information including the change detection history and a terminal ID of the sensor terminal 80 to the repeater 60 (Act 45).

The repeater 60 receives, in the data slot in the basic frame, the environment information transmitted from the sensor terminal 80 (Act 34). The repeater 60 transmits ACK or NACK to all the sensor terminals 80 according to whether the environment information is normally received (Act 35). The ACK or NACK includes the terminal ID of the sensor terminal 80 that transmits the environment information corresponding to the ACK or NACK.

The sensor terminal 80 checks data to the sensor terminal 80 transmitted from the repeater 60 in Act 35 (Act 46) and determines whether the data is ACK indicating that reception thereof is normally completed (Act 47). If the sensor terminal 80 determines that the data is the ACK (Yes in Act 47), the sensor terminal 80 returns to Act 41 and resumes the sensing of acceleration. If the sensor terminal 80 determines in Act 47 that the data is NACK (No in Act 47), the sensor terminal 80 returns to Act 44 and stays on standby until transmission permission is obtained from the repeater 60. When transmission permission is obtained from the repeater 60, the sensor terminal 80 retransmits the environment information using the data slot.

On the other hand, when the ESL server 30 receives the environment information from the repeater 60, the ESL server 30 determines whether a measurement value (acceleration) included in the environment information, i.e., a value representing the magnitude of impact is equal to or larger than a predetermined threshold (Act 36). If the ESL server 30 determines that the measurement value is smaller than the threshold (No in Act 36), the ESL server 30 discards the environment information (Act 37) and then returns to Act 31. If the ESL server 30 determines that the measurement value is equal to or larger than the threshold (Yes in Act 36), the ESL server 30 presents a warning message indicating occurrence of impact on the display unit 104 or the like in association with the terminal ID of the sensor terminal 80 included in the environment information (Act 38) and then returns to Act 31.

In this way, since the acceleration sensor is used as the sensor terminal 80, it is possible to detect vibration that occurs in an object (a commodity display shelf, etc.) on which the sensor terminal 80 is set. Therefore, it is possible to predict likelihood that a commodity shelf swings and commodity display collapses or price tags fall and emit a warning to a person in charge.

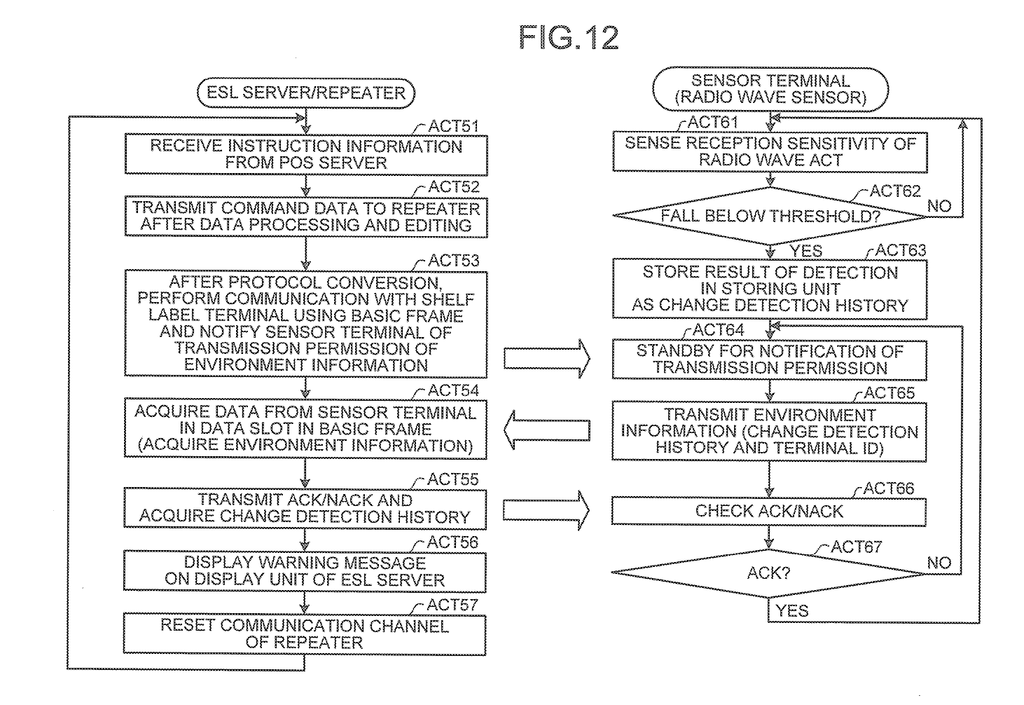

An example of operation performed when a radio wave sensor for sensing reception sensitivity (field intensity) of radio exchanged between the sensor terminal 80 and the repeater 60 is used as the sensor unit 81 of the sensor terminal 80 is explained with reference to FIG. 12. FIG. 12 is a flowchart of an operation example of the store information system in which the radio wave sensor is used as the sensor terminal 80. In FIG. 12, since processing in Act 51 to Act 54 is the same as the processing in Act 31 to Act 34 explained with reference to FIG. 11, explanation of the processing is omitted.

There are various factors that deteriorate a communication environment among the ESL servers 30, the repeaters 60, and the shelf label terminals 70. For example, there are a large number of appliances made of metal in the store and interference is caused by customers coming in and going out of the store and radio apparatuses that use the same frequency. In this operation example, it is assumed that such a change in a radio wave environment is monitored by the sensor terminal 80.

The sensor terminal 80 senses reception sensitivity of a radio wave between the sensor terminal 80 and the repeater 60 always or at every predetermined time (Act 61 and No in Act 62). If the sensor terminal 80 detects that the reception sensitivity falls below a predetermined threshold (Yes in Act 62), the sensor terminal 80 stores a result of the detection in the storing unit 85 as a change detection history (Act 63). Subsequently, the sensor terminal 80 stays on standby until transmission permission is transmitted from the repeater 60 (Act 64). When the sensor terminal 80 receives the transmission permission transmitted from the repeater 60 in Act 53, the sensor terminal 80 transmits environment information including the change detection history stored in the storing unit 85 and a terminal ID of the sensor terminal 80 to the repeater 60 (Act 65).

The repeater 60 receives, in the data slot in the basic frame, the environment information transmitted from the sensor terminal 80 (Act 54). The repeater 60 transmits ACK or NACK to all the sensor terminals 80 according to whether the environment information is normally received (Act 55). The ACK or NACK includes the terminal ID of the sensor terminal 80 that transmits the environment information corresponding to the ACK or NACK.

The sensor terminal 80 checks data to the sensor terminal 80 transmitted from the repeater 60 in Act 55 (Act 66) and determines whether the data is ACK indicating that reception thereof is normally completed (Act 67). If the sensor terminal 80 determines that the data is the ACK (Yes in Act 67), the sensor terminal 80 returns to Act 61 and resumes the sensing of reception sensitivity. If the sensor terminal 80 determines in Act 67 that the data is NACK (No in Act 67), the sensor terminal 80 returns to Act 64 and stays on standby until transmission permission is obtained from the repeater 60. When transmission permission is obtained from the repeater 60, the sensor terminal 80 retransmits the environment information using the data slot.

On the other hand, when the ESL server 30 receives the environment information from the repeater 60, the ESL server 30 presents, on the display unit 104 or the like, a warning message indicating occurrence of electromagnetic interference in which a measurement value (radio wave intensity) included in the environment information and the terminal ID of the sensor terminal 80 are associated with each other (Act 56). The ESL server 30 resets a communication channel of the repeater 60 for improvement of the electromagnetic interference (Act 57) and returns to Act 51.

In this way, since the radio wave sensor is used as the sensor terminal 80, it is possible to detect a change in radio wave intensity in a position where the sensor terminal 80 is set. Therefore, it is possible to monitor whether the shelf label terminal 70 in the ESL system can maintain a satisfactory communication state. When the ESL server 30 cannot control the communication channel of the repeater 60, the sensor terminal 80 immediately returns to Act 51 after Act 56.

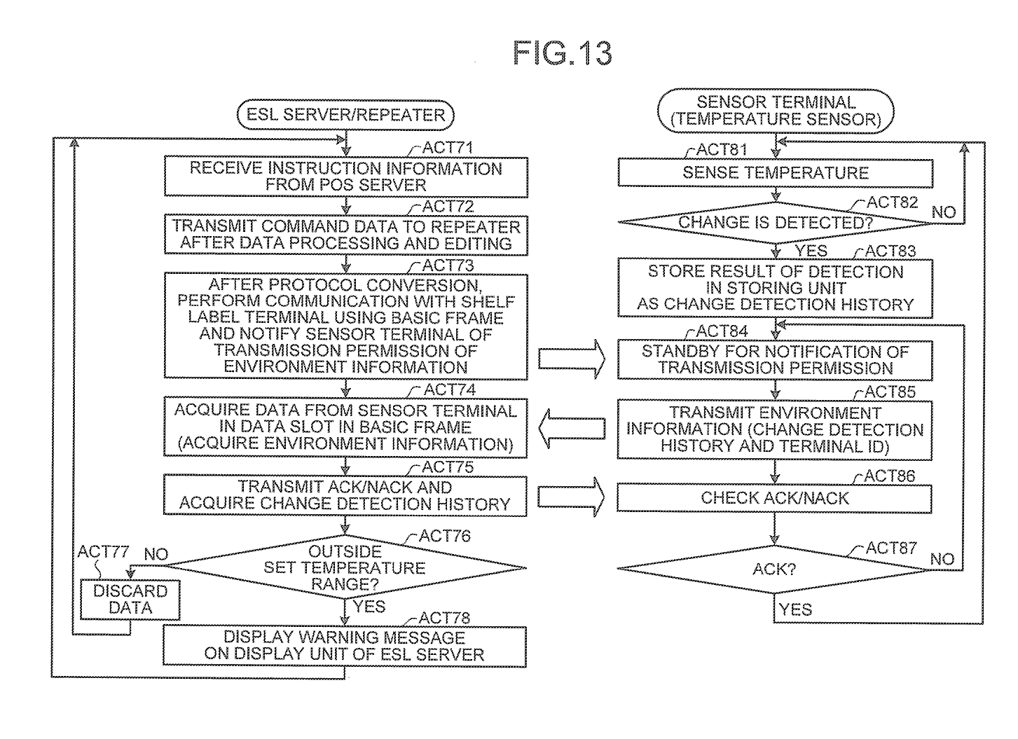

An example of operation performed when a temperature sensor for detecting temperature is used as the sensor unit 81 of the sensor terminal 80 is explained with reference to FIG. 13. FIG. 13 is a flowchart for explaining an operation example of the store information system in which the temperature sensor is used as the sensor terminal 80. In FIG. 13, since processing in Act 71 to Act 74 is the same as the processing in Act 31 to Act 34 explained with reference to FIG. 11, explanation of the processing is omitted.

Among commodities displayed in the store, there are commodities sensitive to temperature or requiring temperature management such as daily delivery products, fresh foods, and frozen foods. In this operation example, it is assumed that the sensor terminal 80 including the temperature sensor is arranged near these commodities to monitor a temperature change near the commodities with the sensor terminal 80.

The sensor terminal 80 senses ambient temperature always or at every predetermined time (Act 81 and No in Act 82). If the sensor terminal 80 detects a temperature change (Yes in Act 82), the sensor terminal 80 stores temperature at this point in the storing unit 85 as a change detection history (Act 83). The sensor terminal 80 stays on standby until transmission permission is transmitted from the repeater 60 (Act 84). When the sensor terminal 80 receives the transmission permission transmitted from the repeater 60 in Act 73, the sensor terminal 80 transmits environment information including the change detection history stored in the storing unit 85 and a terminal ID of the sensor terminal 80 to the repeater 60 (Act 85).

The repeater 60 receives the environment information transmitted from the sensor terminal 80 in the data slot in the basic frame (Act 74). The repeater 60 transmits ACK or NACK to all the sensor terminals 80 according to whether the environment information is normally received (Act 75). The ACK or NACK includes the terminal ID of the sensor terminal 80 that transmits the environment information corresponding to the ACK or NACK.

The sensor terminal 80 checks data to the sensor terminal 80 transmitted from the repeater 60 in Act 75 (Act 86) and determines whether the data is ACK indicating that reception thereof is normally completed (Act 87). If the sensor terminal 80 determines that the data is the ACK (Yes in Act 87), the sensor terminal 80 returns to Act 81 and resumes the sensing of ambient temperature. If the sensor terminal 80 determines in Act 87 that the data is MACK (No in Act 87), the sensor terminal 80 returns to Act 84 and stays on standby until transmission permission is obtained from the repeater 60. When transmission permission is obtained from the repeater 60, the sensor terminal 80 retransmits the environment information using the data slot.

On the other hand, when the ESL server 30 receives the environment information from the repeater 60, the ESL server determines whether a measurement value (temperature) included in the environment information is outside a predetermined range of set temperature (Act 76). If the ESL server 30 determines that the measurement value is within the range of the set temperature (No in Act 76), the ESL server 30 discards the environment information (Act 77) and returns to Act 71. If the ESL server 30 determines that the measurement value is outside the range of the set temperature (Yes in Act 76), the ESL server 30 presents a warning message indicating occurrence of a temperature change on the display device or the like in association with the terminal ID of the sensor terminal 80 included in the environment information (Act 78) and then returns to Act 71.

In this way, since the temperature sensor is used as the sensor terminal 80, it is possible to detect temperature around an object (e.g., a commodity display shelf) on which the sensor terminal 80 is set. Therefore, it is possible to realize temperature management around commodities sensitive to temperature and quality management for commodities against a temperature change.

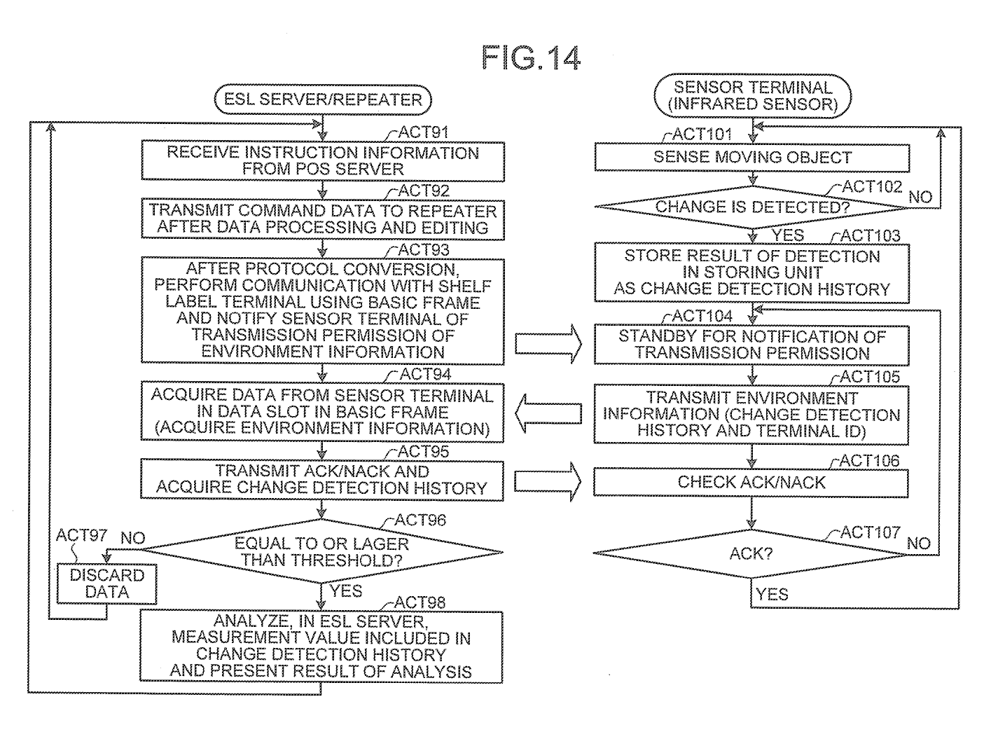

An example of operation performed when an infrared sensor that can detect a moving object such as a human body is used as the sensor unit 81 of the sensor terminal 80 is explained with reference to FIG. 14. FIG. 14 is a flowchart for explaining an operation example of the store information system in which the infrared sensor is used as the sensor terminal 80. In FIG. 14, since processing in Act 91 to Act 94 is the same as the processing in Act 31 to Act 34 explained with reference to FIG. 11, explanation of the processing is explained.

Information such as information concerning what kinds of purchase actions customers perform, in what kinds of commodities the customers are interested in, and how the customers move around in a store is important in planning of a selling floor such as selection of displayed commodities and store layout design. In this operation example, it is assumed that the sensor terminal 80 including the infrared sensor is arranged near a commodity display shelf or commodities to acquire reference information for planning of a selling floor.

The sensor terminal 80 senses a moving object always or at every predetermined time (Act 101 and No in Act 102). If the sensor terminal 80 detects a moving object (Yes in Act 102), the sensor terminal 80 stores a result of the detection (a temporal change amount of the moving object) in the storing unit 85 as a change detection history (Act 103). Subsequently, the sensor terminal 80 stays on standby until transmission permission is transmitted from the repeater 60 (Act 104). When the sensor terminal 80 receives the transmission permission transmitted from the repeater 60 in Act 93, the sensor terminal 80 transmits the change detection history stored in the storing unit 85 and environment information including a terminal ID of the sensor terminal 80 to the repeater 60 (Act 105).

The repeater 60 receives the environment information transmitted from the sensor terminal 80 in the data slot in the basic frame (Act 94). The repeater 60 transmits ACK or NACK to all the sensor terminals 80 according to whether the environment information is normally received (Act 95). The ACK or NACK includes the terminal ID of the sensor terminal 80 that transmits the environment information corresponding to the ACK or NACK.

The sensor terminal 80 checks data to the sensor terminal 80 transmitted from the repeater 60 in Act 95 (Act 106) and determines whether the data is ACK indicating that reception thereof is normally completed (Act 107). If the sensor terminal 80 determines that the data is the ACK (Yes in Act 107), the sensor terminal 80 returns to Act 101 and resumes the sensing of a moving object. If the sensor terminal 80 determines in Act 107 that the data is NACK (No in Act 107), the sensor terminal 80 returns to Act 104 and stays on standby until transmission permission is obtained from the repeater 60. When transmission permission is obtained from the repeater 60, the sensor terminal 80 retransmits the environment information using the data slot.

On the other hand, when the ESL server 30 receives the environment information from the repeater 60, the ESL server 30 determines whether a measurement value (a temporal change amount of the moving object) included in the environment information is equal to or larger than a predetermined threshold (Act 96). If the ESL server 30 determines that the measurement value is smaller than the threshold (No in Act 96), the ESL server 30 discards the environment information (Act 97) and then returns to Act 91. If the ESL server 30 determines that the measurement value is equal to or larger than the threshold (Yes in Act 96), the ESL server 30 analyzes the measurement value included in the environment information, presents a result of the analysis on the display device or the like (Act 98), and then returns to Act 91.

The analysis result is, for example, information in which the positions of the sensor terminals 80 arranged in the store and detection frequencies of the sensor terminals 80 are associated or information in which commodity names of the shelf label terminals 70 arranged near the sensor terminals 80 and detection frequencies of the commodity names are associated.

In this way, since the infrared sensor is used as the sensor terminal 80, it is possible to detect the movement of people near a position where the sensor terminal 80 is set. Therefore, it is possible to investigate purchase actions (moving lines and the movement of hands) of customers.

As explained above, according to this embodiment, the sensor terminal 80 in which the display unit 71 of the shelf label terminal 70 is replaced with the sensor unit 81 is set in the store and the repeater 60 communicates with the shelf label terminal 70 and the sensor terminal 80 using the basic frame. Therefore, it is possible to easily realize the ESL system having a function of the sensor network system, i.e., realize both the electronic shelf label system and the sensor network system. Since it is unnecessary to install the sensor network system in the store, additionally, it is possible to construct a system excellent in cost performance. Further, it is possible to support store management using environment information (vibration of a store space, a state of a radio wave, temperature, and the movement of people) obtained by the sensor network.

The embodiment of the present invention is explained above. However, the present invention is not limited to this. Various modifications, replacements, additions, and the like are possible without departing from the spirit of the present invention.

For example, in the embodiment, the ESL servers 30 are connected to the repeaters 60 via the wired network N1. However, the present invention is not limited to this. The ESL server 30 may be connected to the repeaters 60 using a wireless LAN function of the access point 50. In this case, since a wire cable is unnecessary, it is possible to improve a degree of freedom of setting positions of the repeaters 60.

In the examples explained in the embodiment, the acceleration sensor, the radio wave sensor, the temperature sensor, and the infrared sensor are used as the sensor terminal 80. However, the present invention is not limited to this.

What is claimed is:

1. An information processing apparatus comprising:
a shelf-label control unit connected to plural shelf label terminals, which are arranged in predetermined positions in a store, and configured to transmit instruction information for instructing predetermined operation to each of the shelf label terminals;
an information collecting unit connected to the plural sensor terminals, which are arranged in the predetermined positions in the store, and configured to collect environment information around the arrangement positions acquired by each of the sensor terminals; and
a collection control unit configured to cause the information collecting unit to start the collection of the environment information with response information from the shelf label terminals, which responds to an instruction signal transmitted from the shelf-label control unit, as a trigger.

2. The apparatus according to claim 1, further comprising an alerting unit configured to a user to alert an environment change around the arrangement positions on the basis of a change amount of the environment information collected by the information collecting unit.

3. The apparatus according to claim 1, wherein the shelf label terminals and the sensor terminals are connected to a same network.

4. The apparatus according to claim 1, wherein a period for communication between the information collecting unit and the sensor terminals is provided at a post-stage of a time slot of communication between the shelf-label control unit and the shelf label terminals.

5. The apparatus according to claim 4, wherein the time slot includes a synchronization period for synchronizing the shelf-label control unit and the shelf label terminals and a data communication period for performing data exchange between the shelf-label control unit and the shelf label terminals.

6. The apparatus according to claim 1, wherein the sensor terminals are acceleration sensors for detecting impact on structures in which the sensor terminals are arranged.

7. The apparatus according to claim 1, wherein the sensor terminals are radio wave sensors for detecting reception sensitivity by radio communication with the information collecting unit.

8. The apparatus according to claim 1, wherein the sensor terminals are temperature sensors for detecting temperature around the arrangement positions of the sensor terminals.

9. The apparatus according to claim 1, wherein the sensor terminals are infrared sensors for detecting a moving object around the arrangement positions of the sensor terminals.

10. An information processing method comprising:
a shelf-label control unit transmitting instruction information for instructing predetermined operation to each of plural shelf label terminals arranged in predetermined positions in a store;
an information collecting unit collecting, from the plural sensor terminals arranged in the predetermined positions in the store, environment information around the arrangement positions acquired by the sensor terminals; and
a collection control unit causing the information collecting unit to start the collection of the environment information with response information from the shelf label terminals, which responds to an instruction signal transmitted from the shelf label control unit, as a trigger.
